(19) United States
(12) Patent Application Publication
(10) Pub. No.: US 2026/0057213 A1
(43) Pub. Date: Feb. 26, 2026

(54) EXTENDING FUNCTIONAL NEURAL NETWORK FOR MULTI-CLASS CLASSIFICATION AND DIMENSION REDUCTION OF TIME SERIES DATA

(71) Applicant: Hitachi, Ltd., Tokyo (JP)

(72) Inventors: Aniruddha Rajendra RAO, San Jose, CA (US); Haiyan WANG, Fremont, CA (US); Chetan GUPTA, San Mateo, CA (US)

(21) Appl. No.: 18/813,498

(22) Filed: Aug. 23, 2024

(51) Int. Cl. G06N 3/0455

(52) U.S. Cl. CPC G06N 3/0455

(57) ABSTRACT

Systems and methods described herein extend Functional Neural Networks (FNNs) for time series dimension reduction and multi-class classification. Using functional encoders and decoders, the Bi-Functional Autoencoder (BFAE) reduces both the number of features and timepoints (two way) using basis expansion. FNN is also extended to facilitate time series multi-class classification, which enables detecting more than two classes in the data. The functional encoder uses the continuous neurons in the continuous hidden layer to derive a low-dimension latent representation of the data. This representation is then processed by functional decoder to reconstruct the original information. For multi-class classification, the system utilizes cross-entropy loss and a softmax activation function to effectively handle more than two classes to improve classification performance.

### BACKGROUND

### Field

The present disclosure is generally directed to bi-functional auto encoders (BFAEs), and more specifically, to BFAEs that perform a two-way dimension reduction using a functional neural network (FNN) and to performing multi-Class classification using FNN.

### Related Art

Time series data, data collected over time, is ubiquitous in today's world. Time series analysis provides many organizations valuable insights into trends, patterns, and anomalies in a wide range of applications such as finance, healthcare, manufacturing, and environmental monitoring. Time series classification, the process of categorizing time series data into different classes or categories is essential for many industrial and real-world tasks. For example, in finance, it helps classify financial transactions as fraudulent or legitimate; in healthcare, it aids in diagnosing diseases based on patient monitoring data; and in manufacturing, it predicts equipment failures from sensor data, optimizing maintenance schedules and reducing downtime. However, the exponentially growing volume of time series data poses challenges for storage, transfer, and analysis. Numerous research papers have explored dimension reduction, yet there is a lack of products or services that simultaneously reduce both the number of features and time points in time series data, which would be particularly useful for high-frequency data, such as vibration information from sensors, voice signals, weather data, and the like.

Existing approaches for dimension reduction are developed for multivariate problems, which provide inadequate and linear representations but cannot reduce the number of timepoints. Techniques such as PCA (Principal Component Analysis) and AE (Autoencoder), for example, cannot efficiently capture and model the temporal information in time series data. Similarly, neural networks for classification methods like Long Short-Term Memory (LSTM), Random Forest, and Rocket are either limited by their structure or they completely ignore temporal information.

Functional data analysis (FDA) has proven a robust statistical approach to analyzing time-series data having patterns. Function-on-function models can be used to build mathematical mappings for time series data for dimension reduction. Compared to deep learning (DL) approaches, functional data modeling techniques use function-on-function and function-on-scalar models increasing the efficiency of capturing rich information in time-series data with fewer parameters. Functional data modeling is less restrictive on data format (i.e., data can have different resolutions across samples) and on the underlying mapping (i.e., the parameters can be different at different times within the considered time horizons). However, methods like Functional linear model (FLM), Functional Principal Component Analysis (FPCA), and Functional Autoencoder (FAE) have limitations. FLM for classification assumes linear relationships and is restricted to binary classification. On the other hand, for dimension reduction, FPCA provides only linear representations but cannot capture complex relations, whereas FAE provides only a limiting scalar representation of the data. Dimension reduction based on these methods tends to generate inaccurate results when dealing with complex real-world data.

### SUMMARY

Embodiments herein extend Functional Neural Networks (FNNs) for time series dimension reduction and multi-class classification. Using functional encoders and decoders, the Bi-Functional Autoencoder (BFAE) reduces both the number of features and timepoints (two way) using basis expansion. FNN is extended using appropriate loss and output layer activation functions to facilitate time series multi-class classification, which enables detecting more than two classes in the data.

The functional encoder uses the continuous neurons in the continuous hidden layer to derive a low-dimension latent representation of the data. This representation is then processed by functional decoder to reconstruct the original information.

For multi-class classification, the system utilizes cross-entropy loss and a softmax activation function to effectively handle more than two classes to improve classification performance.

In some aspects of the disclosure, a bi-functional auto encoder (BFAE) performs a two-way dimension reduction using a functional neural network (FNN) and comprises: a functional encoder that, in response to receiving time series information at an input layer of an FNN, performs steps including: processing the time series information through continuous hidden layers, which include continuous neurons, to learn a low-dimensional representation of the time series information; and using a basis expansion to perform a two-way dimension reduction that reduces both a number of features and a number of timepoints in the time series information to decrease at least one of a computation time, a storage need, or a data transfer time; a functional decoder that uses the learned low-dimensional representation to obtain a reconstructed time series information, wherein the functional decoder uses the learned low-dimensional representation of the time series information; and using the low-dimensional representation of the time series information to perform an analytical task.

In some aspects, a time relationship in the continuous hidden layers, which may utilize the continuous neurons to identify at least one of a function or a pattern in the time series information, is preserved. The continuous neurons in the hidden layers may be defined using parameter functions and bivariate parameter functions.

In some aspects, the functional encoder selects a basis function from at least one of B-splines, wavelets, and Fourier functions to increase data capture efficiency. The functional encoder may determine a number of features and a number of time points observed in a latent representation layer. The functional encoder may reduce a dimensionality of the time series information data with minimal information loss. The functional decoder may further reconstruct original time series information from the low-dimensional representation.

In some aspects of the disclosure, a multi-class classification system that uses an FNN comprises: a model learning module that, in a learning phase, builds an FNN model that learns a mapping of time series data to classes associated with the time series data; a model deployment module that in an inference phase uses the mapping to apply the learned FNN model to time series data to detect three or more classes in the time series data, wherein the FNN model is learned by using at least one of a direct method (FDNN) or a basis expansion that each include continuous neurons that form continuous hidden layers; and outputting the three or more classes.

In some aspects, a loss is a cross-entropy loss and an activation function is a softmax activation function.

In some aspects, the techniques described herein relate to a system, wherein the functional encoder captures a non-linear relationship within the time series data.

In some aspects, the techniques described herein relate to a system, wherein the continuous hidden layers utilize the continuous neurons to identify at least one of a function or a pattern in the time series data.

In some aspects, the techniques described herein relate to a non-transitory computer-readable medium for storing instructions for executing a process, the instructions including: at a functional encoder, in response to receiving time series information at an input layer of a functional neural network (FNN) performs steps including: processing the time series information through continuous hidden layers, which include continuous neurons, to learn a low-dimensional representation of the time series information; and using a basis expansion to perform a two-way dimension reduction that reduces both a number of features and a number of timepoints in the time series information to decrease at least one of a computation time, a storage need, or a data transfer time; at a functional decoder that uses the learned low-dimensional representation to obtain a reconstructed time series information, wherein the functional decoder uses the learned low-dimensional representation of the time series information; and using the low-dimensional representation of the time series information to perform an analytical task.

In some aspects, the techniques described herein relate to a non-transitory computer-readable medium for storing instructions for executing a process, the instructions including: in a learning phase, building a functional neural network (FNN) model that learns a mapping of time series data to classes associated with the time series data; in an inference phase, using the mapping to apply the learned FNN model to the time series data to detect three or more classes in the time series data, wherein the FNN model is learned by using at least one of a direct method (FDNN) or a basis expansion that each include continuous neurons that form continuous hidden layers; and outputting the three or more classes.

Aspects of the present disclosure can involve a system, which can involve means for receiving time series information at an input layer of an FNN, and processing the time series information through continuous hidden layers, which include continuous neurons, to learn a low-dimensional representation of the time series information; and means for using a basis expansion to perform a two-way dimension reduction that reduces both a number of features and a number of timepoints in the time series information to decrease at least one of a computation time, a storage need, or a data transfer time. Aspects of the present disclosure can involve a system, which can involve means for a functional decoder that uses the learned low-dimensional representation to obtain a reconstructed time series information, wherein the functional decoder uses the learned low-dimensional representation of the time series information; and means for using the low-dimensional representation of the time series information to perform an analytical task.

Aspects of the present disclosure can involve a system, which can involve means for building, in a learning phase, an FNN model that learns a mapping of time series data to classes associated with the time series data; means for using the mapping, in an inference phase, to apply the learned FNN model to the time series data to detect three or more classes in the time series data, wherein the FNN model is learned by using at least one of an FDNN or a basis expansion that each include continuous neurons that form continuous hidden layers; and means for outputting the three or more classes.

### BRIEF DESCRIPTION OF DRAWINGS

FIG. 1 illustrates an exemplary data-driven system for dimension reduction of time series data according to various embodiments of the present disclosure.

FIG. 2 is an illustration of a general BFAE architecture for dimension reduction according to various embodiments of the present disclosure.

FIG. 3 is a flow diagram illustrating an application of the learned model for dimension reduction of time series data according to various embodiments of the present disclosure.

FIG. 4 illustrates an exemplary data-driven system for multi-class classification of time series data according to various embodiments of the present disclosure.

FIG. 5 illustrates a general FNN architecture for multi-class classification according to various embodiments of the present disclosure.

FIG. 6 is a flowchart illustrating an exemplary two-way dimension reduction process in accordance with various embodiments of the present disclosure.

FIG. 7 is a flowchart illustrating an exemplary process for multi-class classification in accordance with various embodiments of the present disclosure.

FIG. 8 illustrates an example computing environment with an example computer device.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Rapid advancements in technology demand ever-increasing data storage capabilities. The exponential growth of information, especially in time series data, has been exponential, calling for systems and methods for efficiently storing vast amounts of information with minimal signal loss. In many cases, this information is not independent and exhibits complex relations, making the problem more challenging. Dimension reduction plays a key role in addressing this issue by reducing the information in a meaningful manner.

Mathematically, the primary objective of dimension reduction is to decrease dimensionality by projecting the data to a lower dimensional subspace with minimal loss of information. This helps identify important variables and their interactions, addressing the curse of dimensionality, casing information transfer, and reducing both storage requirements and computation time.

The usefulness of dimension reduction makes it an active area of research. In recent years, developing dimension reduction models has proven beneficial in many fields, including time series, text, image, and video analysis. Conversely, time series classification plays a crucial role in the modern world, enabling predictive analytics, anomaly detection, and informed decision-making across various industries. It allows businesses to forecast future trends, anticipate equipment failures, and detect anomalies in data, leading to improved efficiency and cost savings. In healthcare, time series classification aids in diagnosing diseases and monitoring patient health. In environmental monitoring, it helps predict weather patterns and natural disasters. In finance, time series classification supports fraud detection and stock market forecasting, providing valuable insights for risk management and decision-making processes.

Moreover, time series classification is instrumental in smart manufacturing, optimizing production processes, and enabling predictive maintenance strategies. It also plays a vital role in energy management, predicting energy consumption, and promoting sustainable practices. Overall, time series classification is a versatile and essential tool that continues to drive advancements in various industries, enhancing efficiency, and enabling informed decision-making in the face of complex and dynamic data.

Multi-class classification is indispensable in scenarios where data needs to be categorized into more than two classes, offering a nuanced understanding of complex real-world problems. It provides a richer perspective on the relationships between different classes and their characteristics, aiding in more detailed data analysis. In practical applications, such as email classification or image recognition, multi-class classification enables the categorization of data into multiple categories, like spam, promotions, and primary inboxes for emails, or various objects or animals in images. This detailed classification is crucial for making informed decisions and gaining deeper insights into the data.

Compared to binary classification, multi-class classification presents greater challenges due to the increased number of classes and the complexity of distinguishing between them, which is exacerbated for time series data. However, this complexity also makes it an important area of research in machine learning, driving advancements in classification algorithms. Multi-class classification offers a comprehensive evaluation of classifier performance, considering not only overall accuracy but also the classifier's effectiveness for each individual class. This holistic evaluation is essential for understanding the strengths and limitations of a classifier, leading to more robust and reliable classification systems.

Embodiments provide for data-driven systems and methods that effectively learn the mathematical mapping of the time series to a low-dimensional latent space without loss of information. This is advantageous for use cases such as voice signals or vibration information, which are measured at very high frequency, and temperature readings, which are recorded at a very granular resolution. In these scenarios, accurate and compact information is very important for performing the various downstream tasks.

Some data-driven embodiments effectively learn the mathematical mapping of the time series to its labels or classes (multi-class) for use cases such as anomaly detection, weather classification etc. In these applications, learning temporal information leads to improved performance.

In short, various embodiments extend the Functional Neural Network (FNN) approach such that it can be used (with slight modifications) for both classification and dimension reduction tasks, effectively by making use of the temporal nature of the data.

Unlike existing approaches, multi-class classification for time-series data embodiments herein offers several advantages. They automatically capture non-linear relationships existing in the data and can efficiently classify more than two classes by using either the direct method or basis expansion. The superiority of these systems and methods has been demonstrated through real-world data analysis. This forecasting approach is valuable in various scenarios, including industries where time series information with multiple classes is available, and where multi-class classification is common in real-world problems.

In addition, two-way dimension reduction embodiments herein approach present significant benefits compared to existing methods. These embodiments automatically capture non-linear relationships in the data and can reduce both the number of features and the time points at which the time series is observed. By using basis functions, a system can capture the data more efficiently with appropriate functions. The superiority of these systems and methods also has been confirmed through real-world data analysis. These embodiments are particularly valuable in industries where information is stored at high frequency, addressing the global issue of data storage and transfer costs. Using accurately dimension-reduced data enables faster and more accurate analyses.

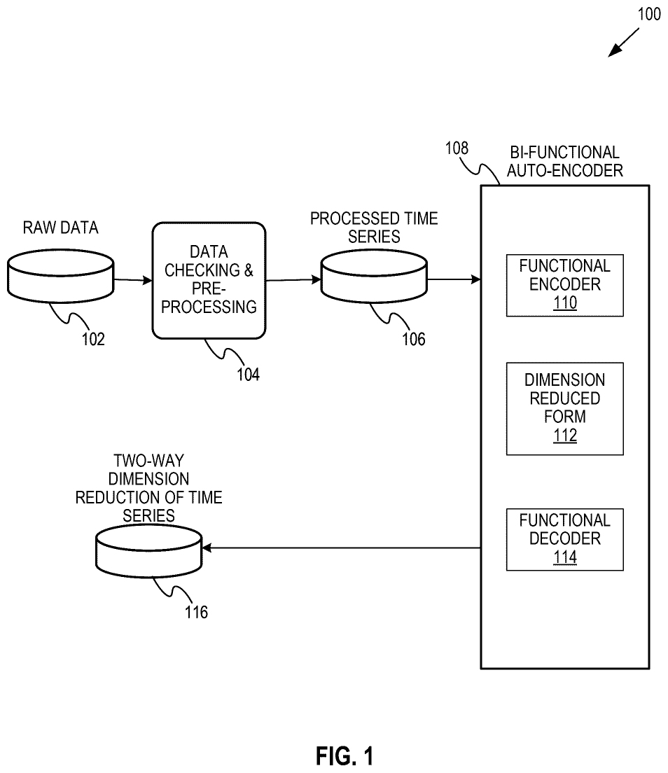

FIG. 1 illustrates an exemplary data-driven system for dimension reduction of the time series data according to various embodiments of the present disclosure. In embodiments, system 100 comprises data checking and data pre-processing module 104, and BFAE module 108. BFAE module 108, may comprise functional encoder 110, dimension-reduced form 112, and functional decoder 114.

In operation, data checking and data pre-processing module 104 aims at ensuring that time series data 102 (e.g., weather data) is regularly observed over time (e.g. hourly), without significant time gaps between adjacent observations.

Data checking and data pre-processing module 104 may perform steps before the data is used as an input to a machine learning (ML) or deep learning (DL) algorithm. Such data preparation steps may be performed on the input data before it is input to these algorithms. It is noted that no specific data preparation method is required. Examples of data checking and data pre-processing steps include noise/outlier identification and removal, missing data imputation, and the like. Once the data is preprocessed in this manner, it may be divided into training and testing sets. The training set is used during the model training phase, while the testing set is used for evaluating the model.

BFAE module 108 conducts the learning phase for dimension reduction. In embodiments, this is accomplished with the help of a functional encoder 110, which obtains compact latent representation 112 of the time series information. Functional decoder 114 obtains the original time series information back from the learned latent representation. A BFAE applying module (not shown) may, e.g., in an inference phase, apply the learned dimension reduction model to new data.

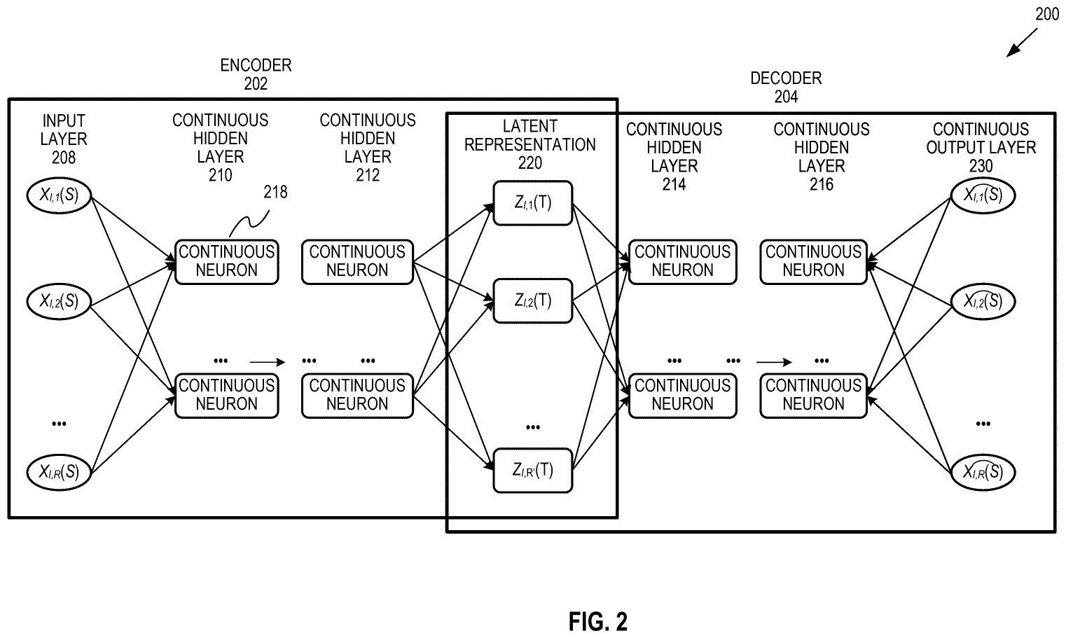

Using the following mathematical notations, assuming that the number of samples is N, for each data sample, the time series data is observed within time range T. The observed data is defined using X_{(i,r)}(s_{i,j}), with s∈S (compact internal) for j=1, . . . , M, i=1, . . . , N, r=1, . . . , R. Time series data may be fed into a neural network architecture shown in FIG. 2.

FIG. 2 illustrates a general BFAE architecture for dimension reduction according to various embodiments of the present disclosure. As depicted, BFAE architecture 200 comprises encoder 202 and decoder 204 that operate on neural network 206. Neural network 206 comprises input layer 208, continuous hidden layers 210-216, latent representation 220, and continuous output layer 230. BFAE architecture 200 identifies the underlying patterns in the data to create a compact latent representation. In embodiments, BFAE architecture 200 accomplished this by leveraging neural network 206 to find complex relations within patterns. BFAE comprises continuous neurons (e.g., 218) that make up continuous hidden layers 210-216. An l^{th} continuous hidden layer and an R^{th} continuous neuron may be defined as follows:

$${H}_{( l )}^{( i , r )} ( s ) = σ ( {b}_{( l )}^{( r )} ( s ) + {\sum }_{j = 1}^{J} \int {w}_{( l )}^{( r , j )} ( s , t ) {H}_{( l - 1 )}^{( r , j )} ( t ) d t ) ,$$

where σ is the activation function,

$${b}_{( l )}^{( r )} ( s )$$

is the parameter function, and

$${w}_{( l )}^{( r , j )} ( s , t )$$

is the bivariate parameter function. A continuous neuron is expanded using basis function as follows:

$${H}_{( l )}^{( i , r )} ( s ) = σ ( {B}_{( l )}^{( r )} {v}_{( l )}^{( r ) *} ( s ) + {\sum }_{j = 1}^{J} \int {W}_{( l )}^{( r , j )} {v}_{( l )}^{( r , j )} ( s ) {v}_{( l )}^{( r , j )} ( t ) {H}_{( l - 1 )}^{( i , j )} ( t ) d t )$$

and backpropagation for a continuous neuron may be expanded using basis function as follows:

$$\frac{\partial {H}_{( l )}^{( i , r )}}{\partial {B}_{( l )}^{( r )}} = {σ}^{′} ( {B}_{( l )}^{( r )} {v}_{( l )}^{( r ) *} ( s ) + {\sum }_{j = 1}^{J} \int {W}_{( l )}^{( r , j )} {v}_{( l )}^{( r , j )} ( s ) {v}_{( l )}^{( r , j )} ( t ) {H}_{( l - 1 )}^{( i , j )} ( t ) d t ) {v}_{( l )}^{( r ) *} ( s )$$

$$and$$

$$\frac{\partial {H}_{( l )}^{( i , r )}}{\partial {W}_{( l )}^{( r , j )}} = {σ}^{′} ( {B}_{( l )}^{( r )} {v}_{( l )}^{( r ) *} ( s ) + {\sum }_{{j}^{′} = 1}^{J} \int {W}_{( l )}^{( r , {j}^{′} )} {v}_{( l )}^{( r , {j}^{′} )} ( s ) {v}_{( l )}^{( r , {j}^{′} )} ( t ) {H}_{( l - 1 )}^{( i , {j}^{′} )} ( t ) d t ) {v}_{( l )}^{( r , j )} ( t ) {H}_{( l - 1 )}^{( i , j )} ( t ) ,$$

where

$${B}_{( l )}^{( r )} ,$$

$${W}_{( l )}^{( r , j )}$$

are unknown matrixes and

$${v}_{( l )}^{( r ) *} ( s ) ,$$

$${v}_{( l )}^{( r , {j}^{′} )} ( s ) ,$$

$${v}_{( l )}^{( r , {j}^{′} )} ( t )$$

are known basis functions (e.g., B splines, wavelet, or Fourier).

Using the defined continuous neurons and derivatives, forward and backward propagation can be completed. This process may iterate between the forward and backward propagation until a stopping criterion is reached. The BFAE performs dimension reduction through a functional encoder, which passes the information from input layer 208 through multiple continuous hidden layers 210-216 until reaching layer 220 that produces a compact (i.e., compressed in number of features and/or number of timepoints) latent representation of the time series information, denoted by

$${Z}_{( {l}^{′} )}^{( {R}^{′} )} ( t ) .$$

The functional decoder then constructs the original time series information 230 from the learned latent representation. The number of features and the number of timepoints at which the features are observed in latent representation layer 220 may be freely chosen.

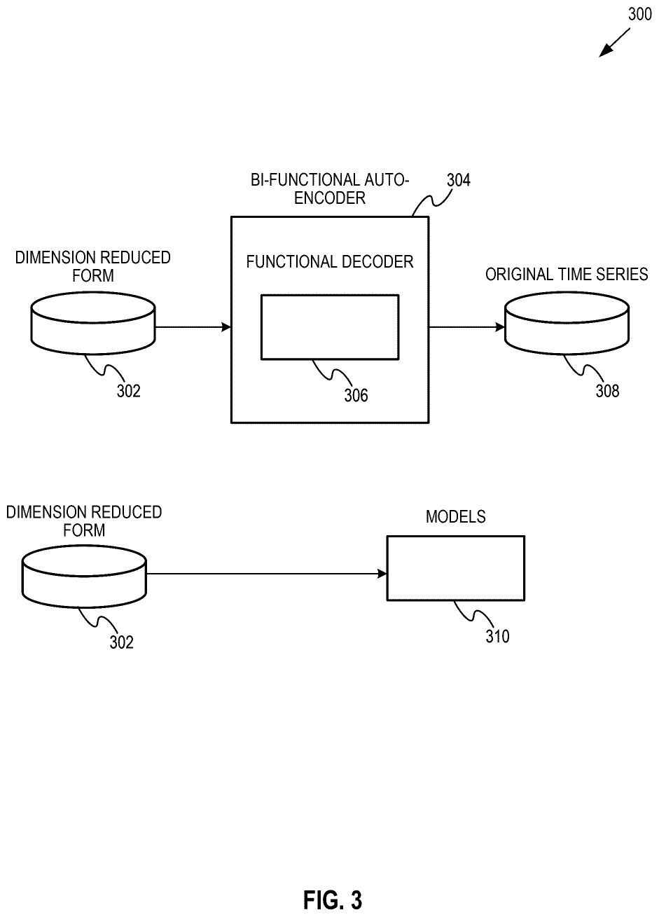

FIG. 3 is a flow diagram illustrating an application of the learned model for dimension reduction of time series data according to various embodiments of the present disclosure. In embodiments, the learned model for time series data may be applied by BFAE model applying module (not shown) to perform steps comprising (1) using the dimension-reduced form 302 output by the model learned by functional decoder 306 to retrieve or reconstruct original time series data 308, and (2) using dimension-reduced form 302 output by the model learned by the functional encoder to obtain a compact form of the data that may be used in various analytical tasks 310.

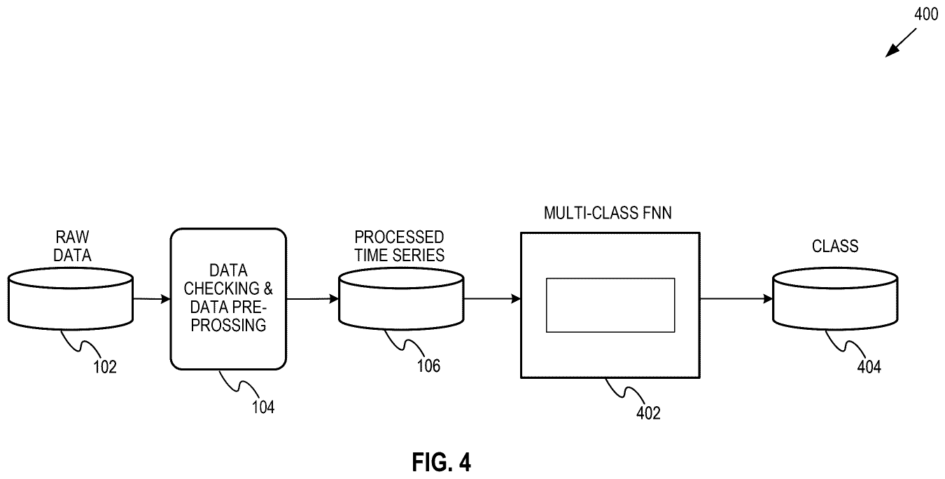

FIG. 4 illustrates an exemplary data-driven system for multi-class classification of time series data according to various embodiments of the present disclosure. In embodiments, system 400 comprises data checking and data pre-processing module 104, and multi-class FNN 402. In operation, data checking and data pre-processing module 104 aims at ensuring that the time series data to be used in the later calculation is regularly observed over time, without significant time gaps between adjacent observations. Data checking and data pre-processing module 104 may perform steps before the data is used as an input to an ML or DL algorithm. Such data preparation steps may be performed on the input data before it is input to these algorithms. It is noted that no specific data preparation method is required. Examples of data checking and data pre-processing steps include noise/outlier identification and removal, missing data imputation, and the like. Once the data is preprocessed in this manner, it may be divided into training and testing sets. The training set is used during the model training phase, while the testing set is used for evaluating the model.

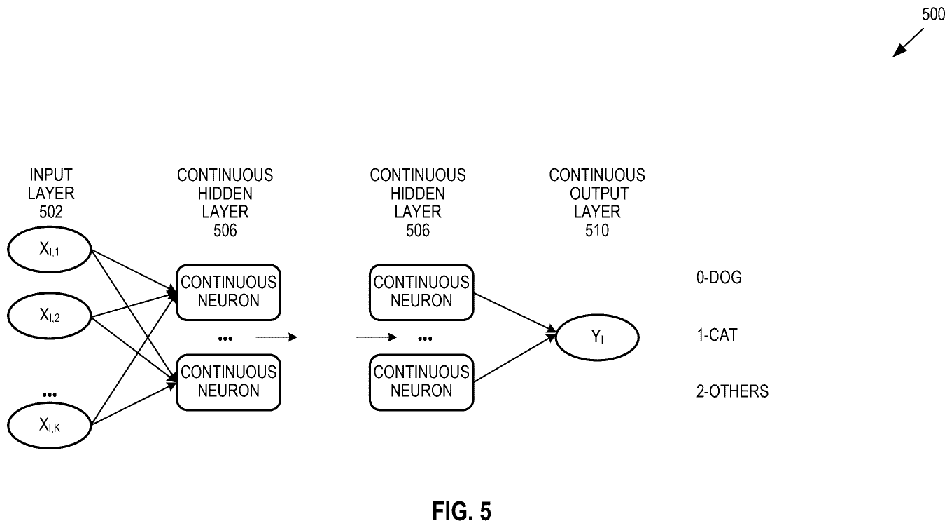

In embodiments, a multi-class model module (not shown) may conduct the learning phase for developing a model from FNN for multi-class classification using processed time series data 106. Based on the results obtained from the multi-class model module, a multi-class model applying module (not shown) may apply the learned model. For the multi-class model module, the following mathematical notations are used: Assuming that the number of samples is N, for each data sample, the time series data is observed within time range T. The observed data is defined using X_{i,j}(t_{i,j}), with t_{i,j}∈T for j=1, . . . , M, i=1, . . . , N. Since the modeling task is multi-class classification, there exist more than two labels or classes. Time series data may be fed into a neural network architecture shown in FIG. 5 to obtain the output class.

FIG. 5 illustrates a general FNN architecture for multi-class classification according to various embodiments of the present disclosure. FNN architecture 500 comprises input layer 502, continuous hidden layers 504-506, and continuous output layer 510. FNN architecture 500 identifies the underlying patterns in the data to optimize the model to find complex relations within patterns.

FNN 500 comprises continuous neurons (e.g., 508) that make up continuous hidden layers 504-506. An l^{th} continuous hidden layer and a r^{th} continuous neuron may be defined as follows:

$${H}_{( l )}^{( i , r )} ( s ) = σ ( {b}_{( l )}^{( r )} ( s ) + {\sum }_{j = 1}^{J} \int {w}_{( l )}^{( r , j )} ( s , t ) {H}_{( l - 1 )}^{( r , j )} ( t ) dt ) ,$$

where σ is the activation function,

$${b}_{( l )}^{( r )} ( s )$$

is the parameter function, and

$${w}_{( l )}^{( r , j )} ( s , t )$$

is the bivariate parameter function. Using the defined continuous neurons, the forward and backward propagation can be completed and partial derivatives may be computed to update the parameter functions in the backpropagation step. This process iterates between forward and backward propagation until a stopping criterion is reached. FNN 500 has the flexibility to consider other functional features that enable improving the current results. The number of continuous hidden layers, number of continuous neurons in each of the continuous hidden layer, and the activation functions may be freely chosen. This approach of optimizing network 500 is called Functional Direct Neural Network (FDNN). The loss used is cross-entropy loss and the output activation function is softmax.

Another way of solving the network is through functional basis neural network (FBNN). In such embodiments, the continuous neuron is expanded using basis function as follows:

$${H}_{( l )}^{( i , r )} ( s ) = σ ( {B}_{( l )}^{( r )} {v}_{( l )}^{( r ) *} ( s ) + {\sum }_{j = 1}^{J} \int {W}_{( l )}^{( r , j )} {v}_{( l )}^{( r , j )} ( s ) {v}_{( l )}^{( r , j )} ( t ) {H}_{( l - 1 )}^{( i , j )} ( t ) d t )$$

and the Backward propagation for a continuous neuron are as follows:

$$\frac{\partial {H}_{( l )}^{( i , r )}}{\partial {B}_{( l )}^{( r )}} = {σ}^{′} ( {B}_{( l )}^{( r )} {v}_{( l )}^{( r ) *} ( s ) + {\sum }_{j = 1}^{J} \int {W}_{( l )}^{( r , j )} {v}_{( l )}^{( r , j )} ( s ) {v}_{( l )}^{( r , j )} ( t ) {H}_{( l - 1 )}^{( i , j )} ( t ) dt ) {v}_{( l )}^{( r ) *} ( s )$$

$$and$$

$$\frac{\partial {H}_{( l )}^{( i , r )}}{\partial {W}_{( l )}^{( r , l )}} = {σ}^{′} ( {B}_{( l )}^{( r )} {v}_{( l )}^{( r ) *} ( s ) + {\sum }_{{j}^{′} = 1}^{J} \int {W}_{( l )}^{( r , {j}^{′} )} {v}_{( l )}^{( r , {j}^{′} )} ( s ) {v}_{( l )}^{( r , {j}^{′} )} ( t ) {H}_{( l - 1 )}^{( i , {j}^{′} )} ( t ) dt ) {v}_{( l )}^{( r , j )} ( t ) {H}_{( l - 1 )}^{( i , j )} ( t ) ,$$

where

$${B}_{( l )}^{( r )} ,$$

$${W}_{( l )}^{( r , j )}$$

are unknown matrixes and

$${v}_{( l )}^{( r ) *} ( s ) ,$$

$${v}_{( l )}^{( r , {j}^{′} )} ( s ) ,$$

$${v}_{( l )}^{( r , {j}^{′} )} ( t )$$

are known basis functions (e.g., B splines, wavelet, or Fourier)

Although not explicitly shown, it is understood that, embodiments for multi-class classification of the time series model utilize a data collection and storage module that collects historical data; a model learning unit that utilizes time series data to build a model using the FNN multi-class classification; and a model deployment unit that deploys the learned model on streaming data to produce and transmit the real-time data-driven information.

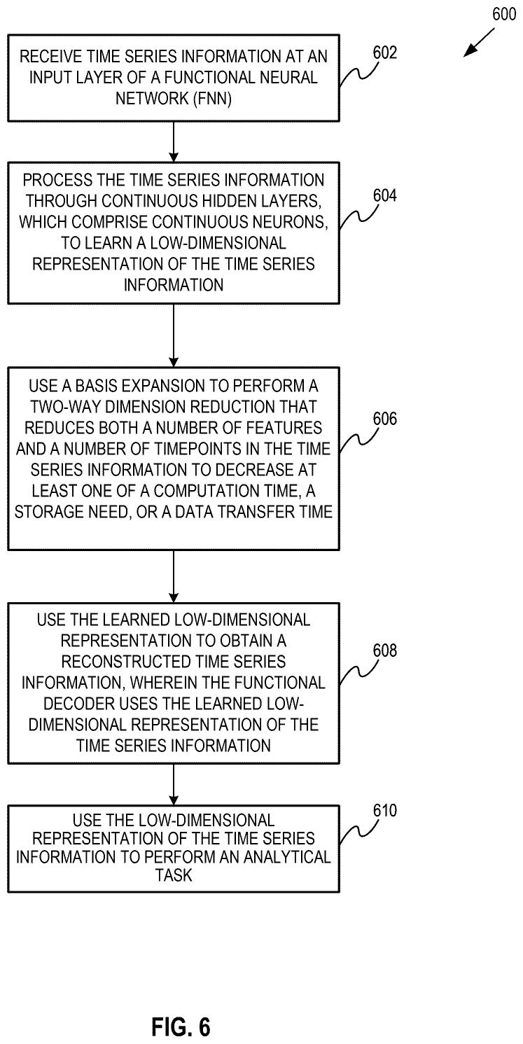

FIG. 6 is a flowchart illustrating an exemplary process for performing a two-way dimension reduction in accordance with various embodiments of the present disclosure. Process 600 may start when a functional encoder receives time series information at an input layer of an FNN.

At step 604, the functional encoder may process the time series information through continuous hidden layers to learn a low-dimensional representation of the time series information. The hidden layers may comprise continuous neurons.

At step 606, the functional encoder may use a basis expansion to perform a two-way dimension reduction that reduces both a number of features and a number of timepoints in the time series information to decrease at least one of a computation time, a storage need, or a data transfer time.

At step 608, a functional decoder may use the learned low-dimensional representation to obtain a reconstructed time series information. In embodiment, the functional decoder may use the learned low-dimensional representation of the time series information.

Finally, at step 610, the low-dimensional representation of the time series information may be used to perform an analytical task.

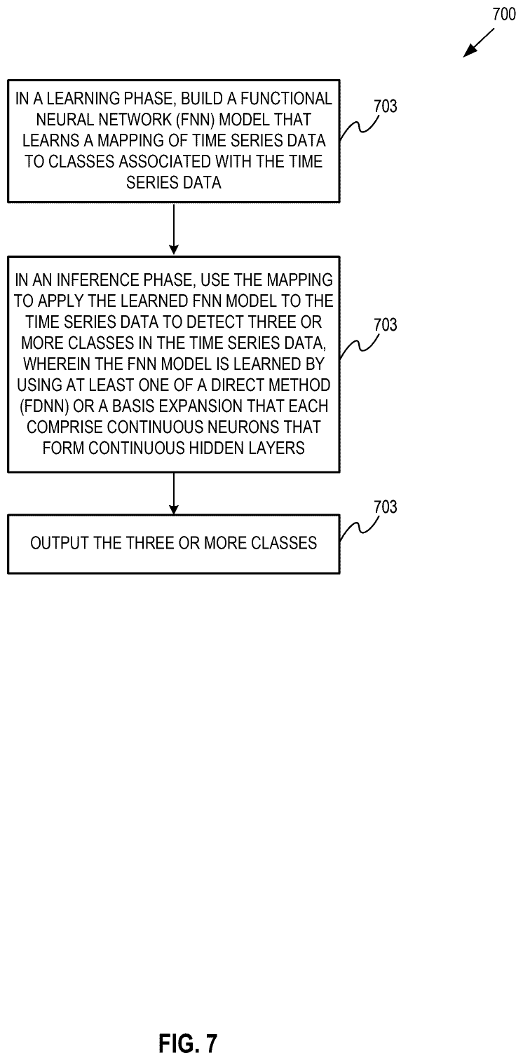

FIG. 7 is a flowchart illustrating an exemplary process for performing a multi-class classification in accordance with various embodiments of the present disclosure. Process 700 may start when, in a learning phase, a model learning module builds an FNN model that learns a mapping of time series data to classes associated with the time series data.

At step 704, in an inference phase, a model deployment module may use the mapping to apply the learned FNN model to time series data to detect three or more classes in the time series data, wherein the FNN model is learned by using at least one of an FDNN or a basis expansion that each comprise continuous neurons that form continuous hidden layers.

At step 706, the three or more classes may then be output.

One skilled in the art shall recognize that: (1) certain steps may optionally be performed; (2) steps may not be limited to the specific order set forth herein; (3) certain steps may be performed in different orders; and (4) certain steps may be done concurrently.

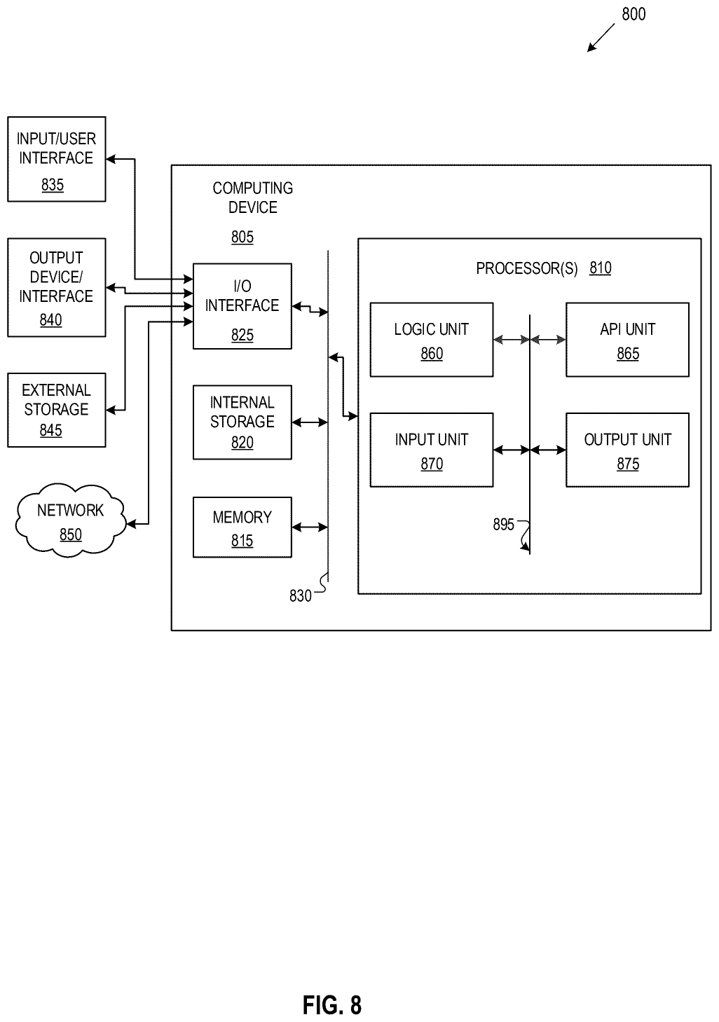

FIG. 8 illustrates an example computing environment with an example computer device suitable for use in some example implementations. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or I/O interface 825, any of which can be coupled on a communication mechanism or bus 830 for communicating information or embedded in the computer device 805. I/O interface 825 is also configured to receive images from cameras or provide images to projectors or displays, depending on the desired implementation.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configurations. Computer device 805 or any connected computer device can be functioning as, providing services of, or referred to as a server, client, thin server, general machine, special-purpose machine, or another label.

I/O interface 825 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, a satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, and output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in example implementations.

Processor(s) 810 can be configured to execute a method or computer instructions which can involve receiving, at an input layer of an FNN, time series information and processing the time series information through continuous hidden layers, which include continuous neurons, to learn a low-dimensional representation of the time series information, as described, for example, with respect to FIG. 2 and FIG. 5.

Processor(s) 810 can be configured to execute a method or computer instructions which can involve using a basis expansion to perform a two-way dimension reduction that reduces both a number of features and a number of timepoints in the time series information to decrease at least one of a computation time, a storage need, or a data transfer time, as described, for example, with respect to FIG. 1.

Processor(s) 810 can be configured to execute a method or computer instructions which can involve using the learned low-dimensional representation to obtain a reconstructed time series information, wherein the functional decoder uses the learned low-dimensional representation of the time series information, and using the low-dimensional representation of the time series information to perform an analytical task, as described, for example, with respect to FIG. 3.

Processor(s) 810 can be configured to execute a method or computer instructions which can involve building, in a learning phase, an FNN model that learns a mapping of time series data to classes associated with the time series data, and using the mapping, in an inference phase, to apply the learned FNN model to the time series data to detect three or more classes in the time series data, wherein the FNN model is learned by using at least one of an FDNN or a basis expansion that each include continuous neurons that form continuous hidden layers before outputting the three or more classes, as described, for example, with respect to FIG. 4 and FIG. 5.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A bi-functional auto encoder (BFAE) that performs a two-way dimension reduction using a functional neural network (FNN), the BFAE comprising:
a functional encoder that, in response to receiving time series information at an input layer of an FNN, performs steps comprising:
processing the time series information through continuous hidden layers, which comprise continuous neurons, to learn a low-dimensional representation of the time series information; and
using a basis expansion to perform a two-way dimension reduction that reduces both a number of features and a number of timepoints in the time series information to decrease at least one of a computation time, a storage need, or a data transfer time;
a functional decoder that uses the learned low-dimensional representation to obtain a reconstructed time series information, wherein the functional decoder uses the learned low-dimensional representation of the time series information; and
using the low-dimensional representation of the time series information to perform an analytical task.

2. The BFAE of claim 1, wherein a time relationship in the continuous hidden layers is preserved.

3. The BFAE of claim 1, wherein the functional encoder selects a basis function from at least one of B-splines, wavelets, and Fourier functions to increase data capture efficiency.

4. The BFAE of claim 1, wherein the continuous hidden layers utilize the continuous neurons to identify at least one of a function or a pattern in the time series information.

5. The BFAE of claim 1, wherein the functional encoder reduces a dimensionality of the time series information data with minimal information loss.

6. The BFAE of claim 1, wherein the functional decoder reconstructs original time series information from the low-dimensional representation.

7. The BFAE of claim 1, wherein a combination of the functional encoder and the functional decoder performs a dimension reduction.

8. The BFAE of claim 1, wherein the functional encoder determines a number of features and a number of time points observed in a latent representation layer.

9. The BFAE of claim 1, wherein the continuous neurons in the hidden layers are defined using parameter functions and bivariate parameter functions.

10. A multi-class classification system using a functional neural network (FNN), the multi-class classification comprising:
a model learning module that, in a learning phase, builds an FNN model that learns a mapping of time series data to classes associated with the time series data;
a model deployment module that in an inference phase uses the mapping to apply the learned FNN model to time series data to detect three or more classes in the time series data, wherein the FNN model is learned by using at least one of a direct method (FDNN) or a basis expansion that each comprise continuous neurons that form continuous hidden layers; and
outputting the three or more classes.

11. The system of claim 10, wherein a time relationship in the continuous hidden layers is preserved.

12. The system of claim 10, wherein a loss is a cross-entropy loss and an activation function is a softmax activation function.

13. The system of claim 10, wherein the continuous neurons in the hidden layers are defined using parameter functions and bivariate parameter functions.

14. A non-transitory computer-readable medium for storing instructions for executing a process, the instructions comprising:
at a functional encoder, in response to receiving time series information at an input layer of a functional neural network (FNN) performs steps comprising:
processing the time series information through continuous hidden layers, which comprise continuous neurons, to learn a low-dimensional representation of the time series information; and
using a basis expansion to perform a two-way dimension reduction that reduces both a number of features and a number of timepoints in the time series information to decrease at least one of a computation time, a storage need, or a data transfer time;
at a functional decoder that uses the learned low-dimensional representation to obtain a reconstructed time series information, wherein the functional decoder uses the learned low-dimensional representation of the time series information; and
using the low-dimensional representation of the time series information to perform an analytical task.

15. A non-transitory computer-readable medium for storing instructions for executing a process, the instructions comprising:
in a learning phase, building a functional neural network (FNN) model that learns a mapping of time series data to classes associated with the time series data;
in an inference phase, using the mapping to apply the learned FNN model to the time series data to detect three or more classes in the time series data, wherein the FNN model is learned by using at least one of a direct method (FDNN) or a basis expansion that each comprise continuous neurons that form continuous hidden layers; and
outputting the three or more classes.
